(19) United States
(12) Patent Application Publication
(10) Pub. No.: US 2008/0080742 A1
(43) Pub. Date: Apr. 3, 2008

(54) APPARATUS FOR CORRECTING MOTION VECTORS AND METHOD THEREOF

(75) Inventors: Hwa-seok SEONG, Suwon-si (KR); Jong-sul Min, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/750,084

(22) Filed: May 17, 2007

(30) Foreign Application Priority Data
Oct. 2, 2006 (KR) 10-2006-097170

(51) Int. Cl. G06K 9/46

(52) U.S. Cl. 382/107; 382/236

(57) ABSTRACT

An apparatus and method for correcting motion vectors are provided. The apparatus includes a vector template mapping unit for generating a plurality of vector templates by mapping motion vectors of a block to be processed and adjacent blocks onto blocks of a plurality of templates that are composed of a plurality of blocks divided into two classes; a class reliability judgment unit for judging reliability of class division of the respective vector templates generated by the vector template mapping unit; a vector template selection unit for selecting the vector template having the highest reliability as a result of judgment of the class reliability judgment unit; and a motion vector correction unit for correcting the motion vector of the block to be processed of a class by using a representative motion vector of the class of the vector template selected by the vector template selection unit.

### CROSS-REFERENCE TO RELATED APPLICATIONS

This application claims priority from Korean Patent Application No. 10-2006-097170, filed Oct. 2, 2006, in the Korean Intellectual Property Office, the entire disclosure of which is incorporated herein by reference.

### BACKGROUND OF THE INVENTION

1. Field of the Invention

Methods and apparatuses consistent with the present invention relate to correcting motion vectors, and more particularly, to an apparatus and method for correcting motion vectors which can effectively reduce the occurrence of distortion of an interpolated image by correcting inaccurate motion vectors through substitution of a motion vector, having been derived using a vector template having the highest reliability among a plurality of vector templates, for a motion vector of a block to be processed.

2. Description of the Related Art

Generally, a frame rate conversion (FRC) is used to process motion blurring by temporarily heightening the resolution of an image through generation of an interpolated frame between the original frames using motion estimation and motion compensation techniques.

The FRC generally uses a block matching algorithm (BMA) for the motion estimation. The BMA estimates a motion vector for each block by comparing two successive frames in the unit of a block. In this case, the motion vector is mainly estimated using the sum of absolute difference (SAD) between two frames, that is, using the sum of absolute differences of pixel values.

However, in an occlusion area in which the foreground and the background existing in a frame have different motions, image information exists in one frame only, and thus the estimated motion vector becomes inaccurate. Also, in an image of repeated patterns and so on, the SAD values between two frames are not discernable from each other, and it becomes difficult to perform accurate motion estimation, thereby degrading the accuracy of estimated motion vectors.

Accordingly, if an interpolated image is generated using such motion vectors, distortion occurs in the interpolated image due to the inaccurate motion vectors, and this deteriorates the picture quality of the image.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus and method for correcting motion vectors and a method thereof, which can effectively reduce the occurrence of distortion of an interpolated image by correcting inaccurate motion vectors through substitution of a motion vector, having been derived using a vector template having the highest reliability among a plurality of vector templates, for a motion vector of a block to be processed.

According to an aspect of the present invention, there is provided an apparatus for correcting motion vectors, according to exemplary embodiments of the present invention, which comprises a vector template mapping unit for generating a plurality of vector templates by mapping motion vectors of a block to be processed and adjacent blocks onto blocks of a plurality of templates that are composed of a plurality of blocks divided into two classes; a class reliability judgment unit for judging the reliability of the class division of the respective vector templates generated by the vector template mapping unit; a vector template selection unit for selecting the vector template having the highest reliability as a result of the judgment of the class reliability judgment unit; and a motion vector correction unit for correcting the motion vector of the block to be processed of a class by using a representative motion vector of the class of the vector template selected by the vector template selection unit.

The two classes may be foreground and background classes, and may be divided from each other by separating the plurality of templates in a horizontal, vertical, or diagonal direction.

The class reliability judgment unit may comprise a representative motion vector calculation unit for calculating the representative motion vector for the respective class, and a vector-class dispersion calculation unit for calculating the degree of dispersion within each class and the degree of dispersion between the classes on the basis of the calculated representative motion vector.

The representative motion vector may correspond to a value obtained by taking a median of the motion vectors of the respective class.

The reliability may be in inverse proportion to the degree of dispersion within each class, and may be in proportion to the degree of dispersion between classes.

The motion vector correction unit may substitute the representative motion vector of the class to which the block to be processed belongs among the classes of the vector template selected by the vector template selection unit, for the motion vector of the block to be processed.

The apparatus may further comprise a template generation unit for generating the plurality of templates.

The plurality of templates may be divided into the different classes.

According to another aspect of the present invention, there is provided a method of correcting motion vectors, which comprises generating a plurality of vector templates by mapping motion vectors of a block to be processed and adjacent blocks onto blocks of a plurality of templates that are composed of a plurality of blocks divided into two classes; judging the reliability of the class division of the respective generated vector templates; selecting the vector template having the highest reliability as a result of the judgment of the reliability; and correcting the motion vector of the block to be processed of a class by using a representative motion vector of the class of the selected vector template.

### BRIEF DESCRIPTION OF THE DRAWINGS

The above and other aspects of the present invention will become more apparent by describing certain exemplary embodiments of the present invention with reference to the accompanying drawings, in which:

FIG. 1 is a block diagram schematically illustrating the whole construction of an apparatus for correcting motion vectors according to an exemplary embodiment of the present invention;

FIG. 2 is a histogram of motion vectors included in an area where the foreground and the background overlap each other;

FIG. 3 is an exemplary view illustrating templates for use in vector template construction according to an exemplary embodiment of the present invention;

FIGS. 4A and 4B are views illustrating a vector template and the corresponding vector distribution for judging the reliability of the vector template according to an exemplary embodiment of the present invention; and

FIG. 5 is a flowchart illustrating a process of correcting motion vectors according to an exemplary embodiment of the present invention.

### DETAILED DESCRIPTION OF EXEMPLARY EMBODIMENTS

Exemplary embodiments of the present invention will now be described in detail with reference to the annexed drawings. In the drawings, the same elements are denoted by the same reference numerals throughout the drawings. In the following description, detailed descriptions of known functions and configurations incorporated herein have been omitted for conciseness and clarity.

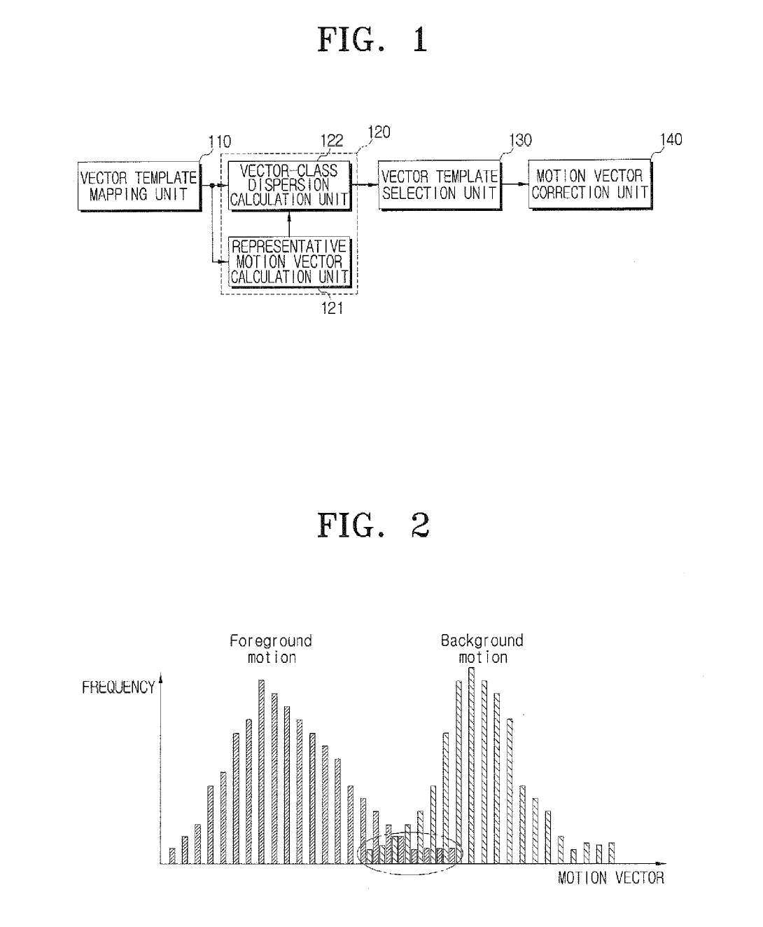

FIG. 1 is a block diagram schematically illustrating the whole construction of an apparatus for correcting motion vectors according to an exemplary embodiment of the present invention.

The apparatus for correcting motion vectors according to an exemplary embodiment of the present invention comprises a vector template mapping unit 110, a class reliability judgment unit 120, a vector template selection unit 130, and a motion vector correction unit 140.

The vector template mapping unit 110 generates a plurality of vector templates by mapping motion vectors of a block to be processed and adjacent blocks onto blocks of a plurality of templates. The plurality of vector templates are generated using the plurality of templates, and the plurality of templates are composed of a plurality of blocks that are divided into two different classes.

The vector templates are used to more accurately derive the motion vector of the block to be processed. FIG. 2 is a histogram of motion vectors included in an area where the foreground and the background overlap each other. The area indicated in dotted line is an area where the judgment of motion is vague, and the accuracy of the estimated motion vector is degraded in this area. This area refers to an occlusion area where motions of the foreground and the background are different from each other or an image area of repeated patterns and so on where the motion estimation is difficult.

In order to estimate the motion vector in the area more accurately, reliabilities of the plurality of vector templates, which are generated by mapping the motion vectors estimated by the motion estimation of the input image onto the plurality of templates that can be generated according to the geometrical positions of the foreground and the background, are respectively judged, and the judged reliabilities are used to derive the motion vector more accurately.

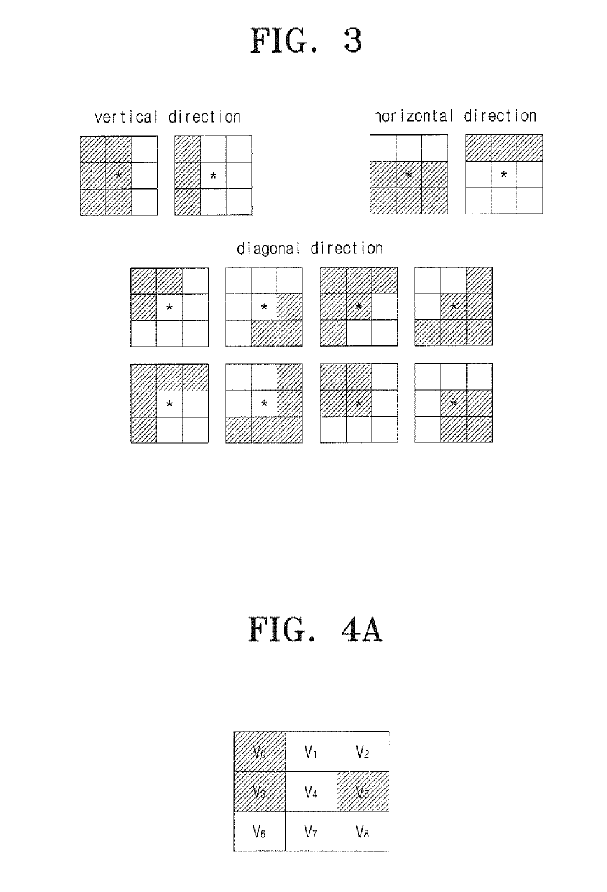

FIG. 3 is an exemplary view illustrating a plurality of templates that can be generated offline in advance so that they can be fetched and used for each block to be processed to generate a plurality of vector templates. The templates are generated by a template generation unit (not illustrated). The respective templates may be formed as 3×3 blocks, and may be divided by two classes in a vertical, horizontal, or diagonal direction. The two classes are the foreground class (i.e., class A) and the background class (i.e., class B). The number of templates may be greater than that illustrated in FIG. 3 in accordance with the number of cases that the foreground class and the background class are separated. The central “*”-marked block of the respective template is a block to be processed, blocks indicated in slant line belong to class A, and block indicated in blank belong to class B.

The respective vector templates are generated by mapping the motion vectors estimated by the motion estimation of the input image in the unit of a block onto the corresponding blocks of the respective templates. Accordingly, the combinations of the motion vectors that belong to class A or class B vary according to the respective vector templates.

The class reliability judgment unit 120 judges the reliability of class division of the respective vector templates generated by the vector template mapping unit 110. The class reliability judgment unit 120 may comprise a representative motion vector calculation unit 121 for calculating a representative motion vector for the respective class, and a vector-class dispersion calculation unit 122 for calculating the degree of dispersion within each class and the degree of dispersion between classes on the basis of the calculated representative motion vector.

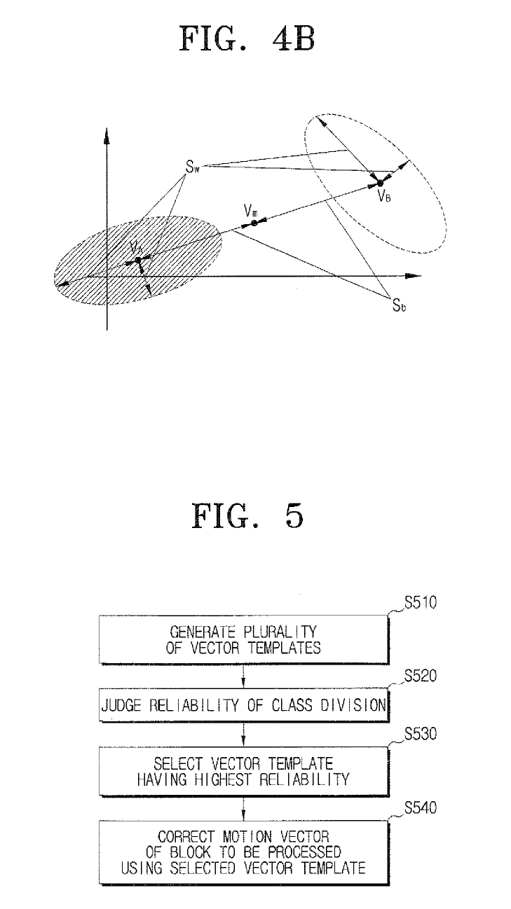

FIG. 4A shows an example of a vector template on which motion vectors are mapped. In FIG. 4A, blocks indicated in slant line belong to class A, and blocks indicated in blank belong to class B. V₄ is a motion vector of a block to be processed, and V₀˜V₃ and V₅˜V₈ are motion vectors of adjacent blocks. In order to judge the reliability of the vector template as constructed in FIG. 4A, the representative motion vector calculation unit 121 calculates the representative motion vector for the respective class by Equation (1).

V_{A}=median{V₀, V₁, V₂, V₃, V₄, V₆}

V_{B}=median{V₅, V₇, V₈} (1)

As shown in Equation (1), the representative motion vector is calculated by obtaining a median of the motion vectors that belong to the respective class. In this case, the reason why the representative motion vector of the respective class is defined as a median, and not as an average value, is to prevent the directions and the sizes of the estimated motion vector from being deformed due to the average value of the motion vectors divided by the respective classes.

Based on the representative motion vectors as calculated above, the vector-class dispersion calculation unit 122 calculates the degree of dispersion Sw within each class and the degree of dispersion Sb between classes by Equation (2).

$${S}_{w} = {S}_{wA} + {S}_{wB} = {\sum }_{i = 0}^{{N}_{A}} \vert {V}_{A} - {V}_{i} \vert + {\sum }_{j = 0}^{{N}_{B}} \vert {V}_{A} - {V}_{j} \vert \\ {S}_{b} = {S}_{bA} + {S}_{bB} \approx \vert {V}_{A} - {V}_{B} \vert \qquad ( 2 )$$

Here, the degree of dispersion S_{w} within each class is defined as the sum of the degree of dispersion S_{wA} within class A and the degree of dispersion S_{wB} within class B, and the degree of dispersion within the respective class is defined by the sum of distances between the representative motion vector calculated by the representative motion vector calculation unit 121 and the motion vectors included in the respective class.

In addition, since the degree of dispersion S_{b} between classes indicates the distance between the averages of class A and class B, it is almost the same as the difference in distance between representative motion vectors of the two classes. Here, S_{bA} denotes a distance from the representative motion vector V_{A} of class A to the average value V_{M} between the representative motion vectors, and S_{bB} denotes a distance from the representative vector V_{B} of class B to the average value V_{M} between the representative motion vectors.

FIG. 4B is a view illustrating vector distribution calculated as described above on the basis of the vector template of FIG. 4A. As shown in FIG. 4B, one ellipse indicated in slant line corresponds to class A and the other ellipse indicated in dotted line corresponds to class B. The two classes are somewhat apart from each other, and it can be seen that the S_{b} and S_{w} values affect the independence between classes.

The class reliability judgment unit 120 judges the reliability of the class division using Equation (3), on the basis of the degrees of dispersion S_{b} and S_{w} calculated by the vector-class dispersion calculation unit 122.

$$J = \frac{{S}_{b}}{{S}_{w}} \qquad ( 3 )$$

As shown in Equation (3), the reliability of the class division is in reverse proportion to the degree of dispersion S_{w} within each class, and is in proportion to the degree of dispersion S_{b} between classes. That is, as S_{w} becomes larger, the consistency among motion vectors constituting each class is lowered, and as S_{b} becomes smaller, the judgment of the foreground and the background becomes vague since the representative motion vectors of the two classes are similar.

Accordingly, as S_{w} becomes smaller and S_{b} comes larger, the overlapping section between classes is decreased, the independence between classes is increased, and the reliability of class division is increased.

The vector template selection unit 130 selects the vector template having the highest reliability as a result of the judgment by the class reliability judgment unit 120 in order to correct the motion vector of the block to be processed.

The motion vector correction unit 140 corrects the motion vector of the block to be processed using the representative motion vector of a class of the vector template selected by the vector template selection unit 130. That is, the motion vector correction unit 140 corrects the motion vector of the block to be processed by substituting the representative motion vector of the class, to which the block to be processed belongs among the classes of the vector template selected by the vector template selection unit 130, for the motion vector of the block to be processed. For example, if the vector template as shown in FIG. 4A is selected as the vector template having the highest reliability, the block V₄ to be processed belongs to foreground class A, and thus the representative motion vector V_{A} of the foreground class A is substituted for the motion vector of the block V₄ to be processed.

FIG. 5 is a flowchart illustrating a process of correcting motion vectors according to an exemplary embodiment of the present invention. First, a plurality of vector templates are generated by mapping motion vectors of the block to be processed and adjacent blocks on respective blocks of a plurality of templates at (S510). Here, the plurality of templates are composed of a plurality of blocks that are divided into two different classes, and the plurality of vector templates are generated by mapping the motion vectors of the block to be processed and the adjacent blocks on the respective blocks of the plurality of templates. Then, the reliability of the class division of the respective vector templates is judged at (S520), and the vector template having the highest reliability as a result of the reliability judgment is selected at (S530). The motion vector of the block to be processed is corrected using the representative motion vector of a class of the selected vector template at (S540).

The judging of the reliability of the class division (S520) comprises calculating a representative vector for the respective class, and calculating the degree of dispersion within the class and the degree of dispersion between classes on the basis of the calculated representative motion vector.

The reliability is inversely proportional to the degree of dispersion within each class, and is proportional to the degree of dispersion between classes.

As described above, according to the apparatus for correcting motion vectors and the method thereof according to the exemplary embodiments of the present invention, the occurrence of distortion of an interpolated image can be effectively reduced by correcting inaccurate motion vectors through substitution of a motion vector, having been derived using a vector template having the highest reliability among a plurality of vector templates, for a motion vector of a block to be processed.

The foregoing embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An apparatus for correcting motion vectors, the apparatus comprising:
a vector template mapping unit which generates a plurality of vector templates by mapping motion vectors of a block to be processed and adjacent blocks onto blocks of a plurality of templates that are composed of a plurality of blocks divided into two classes;
a class reliability judgment unit which judges a reliability of a class division of the plurality of vector templates generated by the vector template mapping unit;
a vector template selection unit which selects a vector template which has a highest reliability as a result of the judgment by the class reliability judgment unit; and
a motion vector correction unit which corrects the motion vectors of the block to be processed which is of a class of the two classes, by using a representative motion vector of a class of the vector template selected by the vector template selection unit.

2. The apparatus of claim 1, wherein the two classes are a foreground class and a background class.

3. The apparatus of claim 2, wherein the two classes are divided from each other by separating the plurality of templates in a horizontal direction, a vertical direction, or a diagonal direction.

4. The apparatus of any one of claims 1 to 3, wherein the class reliability judgment unit comprises:
a representative motion vector calculation unit which calculates the representative motion vector for the two classes; and
a vector-class dispersion calculation unit which calculates a degree of dispersion within the two classes and a degree of dispersion between the two classes based on the calculated representative motion vector.

5. The apparatus of claim 4, wherein the representative motion vector corresponds to a value obtained by taking a median of the motion vectors of the two classes.

6. The apparatus of claim 4, wherein the reliability is inversely proportional to the degree of dispersion within the two classes, and is proportional to the degree of dispersion between the two classes.

7. The apparatus of claim 6, wherein the motion vector correction unit substitutes the representative motion vector of the two classes to which the block to be processed belongs among the two classes of the vector template selected by the vector template selection unit, for the motion vectors of the block to be processed.

8. The apparatus of claim 1, further comprising a template generation unit for generating the plurality of templates.

9. The apparatus of claim 1, wherein the plurality of templates are divided into the two classes.

10. A method of correcting motion vectors, the method comprising:
generating a plurality of vector templates by mapping motion vectors of a block to be processed and adjacent blocks onto blocks of a plurality of templates that are composed of a plurality of blocks divided into two classes;
judging a reliability of a class division of the respective generated vector templates;
selecting a vector template having a highest reliability as a result of the judging of the reliability; and
correcting the motion vectors of the block to be processed which is of a class of the two classes, by using a representative motion vector of a class of the selected vector template.

11. The method of claim 10, wherein the two classes are a foreground class and a background class.

12. The method of claim 11, wherein the two classes are divided from each other by separating the plurality of templates in a horizontal direction, a vertical direction, or a diagonal direction.

13. The method of any one of claims 10 to 12, wherein judging the reliability comprises:
calculating the representative motion vector for the two classes; and
calculating a degree of dispersion within the two classes and a degree of dispersion between the two classes based on the calculated representative motion vector.

14. The method of claim 13, wherein the representative motion vector corresponds to a value obtained by taking a median of the motion vectors of the two classes.

15. The method of claim 13, wherein the reliability is inversely proportional to the degree of dispersion within the two classes, and is proportional to the degree of dispersion between the two classes.

16. The method of claim 15, wherein the correcting the motion vectors substitutes the representative motion vector of the class to which the block to be processed belongs among the classes of the selected vector template, for the motion vector of the block to be processed.
